(19) United States
(12) Patent Application Publication
(10) Pub. No.: US 2008/0014910 A1
(43) Pub. Date: Jan. 17, 2008

(54) METHOD FOR ACQUIRING INFORMATION, AND HAND-HELD MOBILE COMMUNICATIONS DEVICE FOR IMPLEMENTING THE METHOD

(75) Inventors: Yin-Hsong Hsu, Hsichih (TW); Tse-Min Chen, Hsichih (TW); Arif Maskatia, Hsichih (TW)

Correspondence Address: MERCHANT & GOULD PC, P.O. BOX 2903, MINNEAPOLIS, MN, 55402-0903, US

(73) Assignee: ACER INC., Hsichih (TW)

(21) Appl. No.: 11/776,341

(22) Filed: Jul. 11, 2007

Related U.S. Application Data
(63) Continuation-in-part of application No. 11/432,088, filed on May 11, 2006.

(51) Int. Cl. H04Q 7/22

(52) U.S. Cl. 455/414.2

(57) ABSTRACT

A method for acquiring information is implemented in a hand-held mobile communications device to access information in a remote information server through the Internet. The method includes enabling the communications device to acquire partial content of information from the information server at predetermined times, to filter the acquired partial content according to a filtering rule, download information that complies with the filtering rule according to the filtering result, and to display the information complying with the filtering rule or a notification message relating to the information complying with the filtering rule according to a user setting. The method and device permit user convenience and ensure information confidentiality, without incurring extra fees.

### CROSS-REFERENCE TO RELATED APPLICATION

This application is a continuation-in-part (CIP) of U.S. patent application Ser. No. 11/432,088, filed on May 11, 2006.

### BACKGROUND OF THE INVENTION

1. Field of the Invention

The invention relates to a mobile information providing method, more particularly to a method for acquiring information, which is implemented in a hand-held mobile communications device.

2. Description of the Related Art

In this era when developments of Internet and wireless communications technologies flourish, use of a handset to send and receive e-mail has become one of the channels to obtain latest information. In order to facilitate reception of e-mail and to block spam mail, more and more telecommunications service providers provide push mail services, and push mail has recently become a popular subject for discussion.

With the so-called push mail, after the user has set relevant rules or conditions, such as subjects of the mail to be received, or senders of the mail to be received, in a mail server, when contents of an e-mail message received by the mail server comply with the preset rules, the mail server will automatically send a backup copy of the mail to a device of the user, such as a handset or a personal computer. Therefore, the user can have the latest e-mail without having to go through such troublesome procedures as accessing the Internet, inputting his/her account number and user password, etc.

FIG. 1 depicts a push mail service system developed by a company named Research In Motion (RIM) in Canada using the push mail technology. The system provides a push mail server 20 connected to a telecommunications service provider 10 having a cooperative relation with said company, and various mail servers 30 (only one is exemplified). When a user subscribes to a push mail service from the telecommunications service provider 10, and the user has his/her handset 40 loaded with relevant software for the push mail server 20 or the user uses an electronic device supplied by RIM, the user can link up with the push mail server 20 through a personal computer 50 to set parameters of the mail to be received by the handset 40, such as subjects of the mail, senders of the mail, etc. Thereafter, the push mail server 20 will check and screen the e-mail on the mail server 30 according to the rules preset by the user regularly, convert those e-mail messages that comply with the user's preset rules to a specific format suitable for reception by the user's handset 40, and transmit the same to the user's handset 40 through the telecommunications service provider 10.

However, there exist the following problems with the aforesaid push mail service system:
1. The push mail service provider has to invest manpower and time resources to maintain the push mail server 20;
2. Subscribing to the push mail service involves payment of an extra fee to the provider of the push mail server 20; and
3. Since the e-mail for the user is received and screened by the push mail server 20, and is converted to a suitable format by the push mail server 20 before being sent to the user's handset 40, security issues may arise.

Therefore, how to provide push mail functionality while avoiding the aforesaid problems is a subject to be investigated in the present invention.

### SUMMARY OF THE INVENTION

Therefore, the object of the present invention is to provide a method for acquiring information, and a hand-held mobile communications device implementing the method which can overcome the above drawbacks of the prior art.

According to one aspect of the present invention, a method for acquiring information is adapted to be implemented in a hand-held mobile communications device so as to access information in a remote information server through the Internet. The method includes: (A) acquiring partial content of information from the information server at predetermined times; (B) filtering the acquired partial content according to a filtering rule; and (C) according to the filtering result, downloading information that complies with the filtering rule, and according to a user setting, displaying one of the information that complies with the filtering rule and a notification message relating to the information that complies with the filtering rule.

According to another aspect of the present invention, a hand-held mobile communications device is adapted to access information in a remote information server through the Internet. The hand-held mobile communications device includes a communications unit and a processing unit. The communications unit is for communicating with the information server. The processing unit is for acquiring partial content of information from the information server at predetermined times through the communications unit, for filtering the acquired partial content according to a filtering rule, for downloading information that complies with the filtering rule according to the filtering result, and for selectively displaying one of the information that complies with the filtering rule and a notification message relating to the information that complies with the filtering rule according to a user setting.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of the system architecture of a conventional push mail service system;

FIG. 2 is a schematic diagram of a system for the preferred embodiment of a method for acquiring information according to the present invention;

FIG. 3 is a block diagram of the internal hardware architecture of the preferred embodiment of a hand-held mobile communications device according to the present invention;

FIG. 4 is a flowchart of a mail information search using the preferred embodiment of the hand-held mobile communications device;

FIG. 5 is a flowchart to illustrate preliminary screening of electronic mail in the preferred embodiment;

FIG. 6 is a flowchart of an initialization procedure conducted for the preferred embodiment of the hand-held mobile communications device through a personal computer;

FIG. 7 is a schematic diagram showing a “Set Up an E-mail Account” screen in the preferred embodiment;

FIG. 8 is a schematic diagram showing an “Add a New Account” screen in the preferred embodiment;

FIG. 9 is a schematic diagram showing an “Add a POP3 Account” screen in the preferred embodiment;

FIG. 10 is a schematic diagram showing an “Add an iNotes Account” screen in the preferred embodiment;

FIG. 11 is a schematic diagram showing an “Add a Google Mail Account” screen in the preferred embodiment;

FIG. 12 is a schematic diagram showing a “Set Up Mail Filter” screen in the preferred embodiment;

FIG. 13 is a schematic diagram of a home page screen on the hand-held mobile communications device in the preferred embodiment;

FIG. 14 is a schematic diagram showing contents of an e-mail displayed on a display screen of the hand-held mobile communications device in the preferred embodiment;

FIG. 15 is a schematic diagram of another home page screen on the hand-held mobile communications device in the preferred embodiment;

FIG. 16 is a schematic diagram of a “Check Mail Schedule” screen in the preferred embodiment;

FIG. 17 is a schematic diagram of a “Mobile Mail Filter” screen in the preferred embodiment;

FIG. 18 is a schematic diagram of another “Mobile Mail Filter” screen in the preferred embodiment;

FIG. 19 is a schematic diagram of a “Search Mail” screen in the preferred embodiment;

FIG. 20 is a schematic diagram of a “Mail Account” screen in the preferred embodiment;

FIG. 21 is a schematic diagram of a “Mail Account Settings” screen in the preferred embodiment;

FIGS. 22-24 are schematic diagrams of “POP3 Account Settings” screens in the preferred embodiment;

FIG. 25 is a schematic diagram of an “iNotes Account Settings” screen in the preferred embodiment; and

FIG. 26 is a schematic diagram of a menu screen including options of “Filter,” “Mail Account,” “Check Mail Schedule,” and “Backup/Save” in the preferred embodiment.

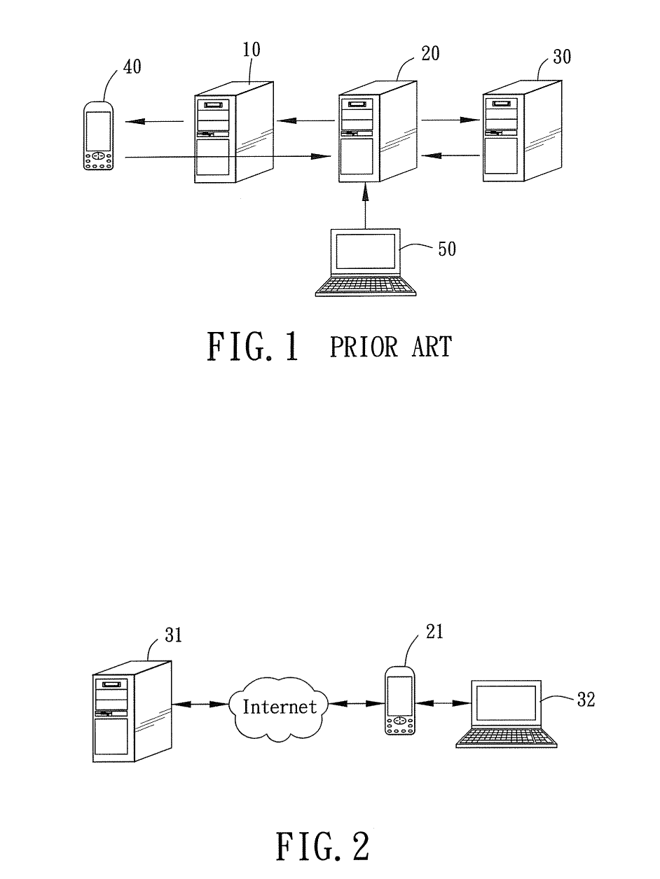

### DETAILED DESCRIPTION OF THE PREFERRED EMBODIMENT

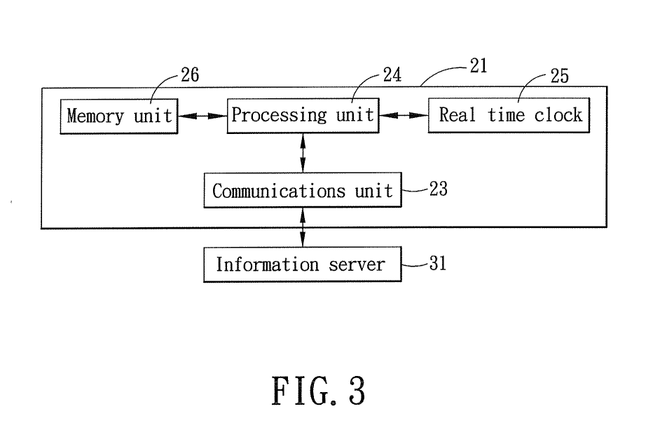

Referring to FIGS. 2 and 3, the preferred embodiment of a hand-held mobile communications device 21 according to the present invention is shown to be able to connect with various remote information servers 31 (only one is exemplified) through the Internet so as to access information in the information servers 31.

In this embodiment, the information server 31 is a mail server, such as the existing Exchange Mail Server, POP3/SMTP Mail Server, Gmail (Google mail) Server, and iNotes Server developed by IBM. In addition, the hand-held mobile communications device 21 of this embodiment is a smart phone having a network accessing function, such as a mobile phone or a PDA phone supporting a wireless communications protocol, e.g., the GPRS (General Packet Radio Service), the WCDMA (Wideband Code Division Multiple Access), the CDMA2000 or the Wi-Fi, and an operating system capable of executing information downloading and reading functions, such as Win CE5.0.

As shown in FIG. 3, the hand-held mobile communications device 21 has a conventional hardware architecture which includes a communications unit 23, a processing unit 24, a real time clock 25, and a memory unit 26. The invention can be implemented with conventional hand-held mobile communication device 21, avoiding altering the hardware thereof.

The communications unit 23 can be connected to the Internet based on, for example, GPRS, WCDMA, CDMA 2000, or Wi-Fi protocols to permit wireless transmission with the information server 31. The real time clock 25 provides time information. An independent power source (not shown) of the hand-held mobile communications device 21 supplies power to the real time clock 25 so as to ensure that the real time clock 25 can still operate even when the hand-held mobile communications device 21 is turned off.

The processing unit 24 not only can execute voice communication, but can also receive filtering rules input from users. The processing unit 24 filters the mails received from the information server 31 according to the predetermined filtering rules. When there are new mails that pass through the filtering rules, the processing unit 24 notifies the user. In addition, the hand-held mobile communications device 21 is loaded with a proprietary mobile mail application program which can control the aforementioned components, and execute the following steps.

The proprietary application program allows the user to set the interval for checking e-mail. Therefore, the application program triggers the processing unit 24 to access the e-mail in the information server 31 at preset intervals according to the timing of the real time clock 25.

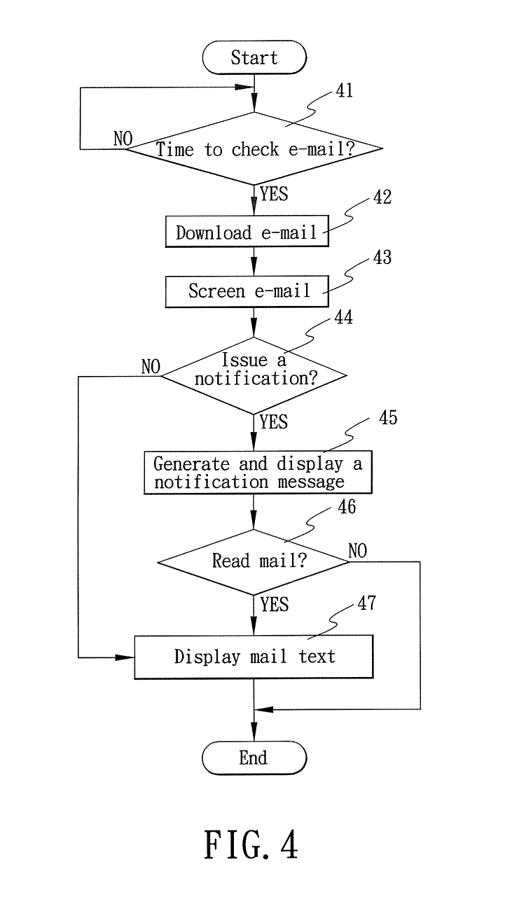

Therefore, in step 41 of FIG. 4, when the mobile communications device 21 is in a standby mode, the application program will not trigger the processing unit 24 to access the e-mail in the information server 31 until the checking e-mail interval has come. At this time, in step 42, the processing unit 24 acquires partial content, such as subject, sender or partial text, of e-mail from the information server 31 through the communications unit 23 and stores the same in the memory unit 26.

In an example where the information server 31 is a POP3 mail server, when the POP3 mail server transmits e-mail to the hand-held mobile communications device capable of receiving and sending e-mail, it will also transmit a unique identifier (UID for short) to the hand-held mobile communications device. Therefore, a conventional hand-held mobile communications device capable of receiving and sending e-mail from and to a POP3 mail server is generally provided with a unique identifier database (not shown) for recording unique identifiers of received e-mail. Before downloading e-mail, the conventional hand-held mobile communications device will request the information server 31 to send thereto the unique identifiers of all the e-mails received thereby, and inspect whether each of the unique identifiers has been recorded in the unique identifier database. E-mail whose unique identifier is not recorded will be regarded as new e-mail and downloaded.

However, as the information server 31 will have stored a large amount of e-mail therein with the passage of time, the mere downloading of the unique identifiers (30˜40K) of the e-mails will take up a lot of bandwidth and time. Moreover, after inspection of the unique identifiers of the downloaded e-mails, it is often found that only some of the e-mails are new e-mails that need to be downloaded. Thus, the conventional hand-held mobile communications device wastes network bandwidth and processing time, and its power consumption is also considerable.

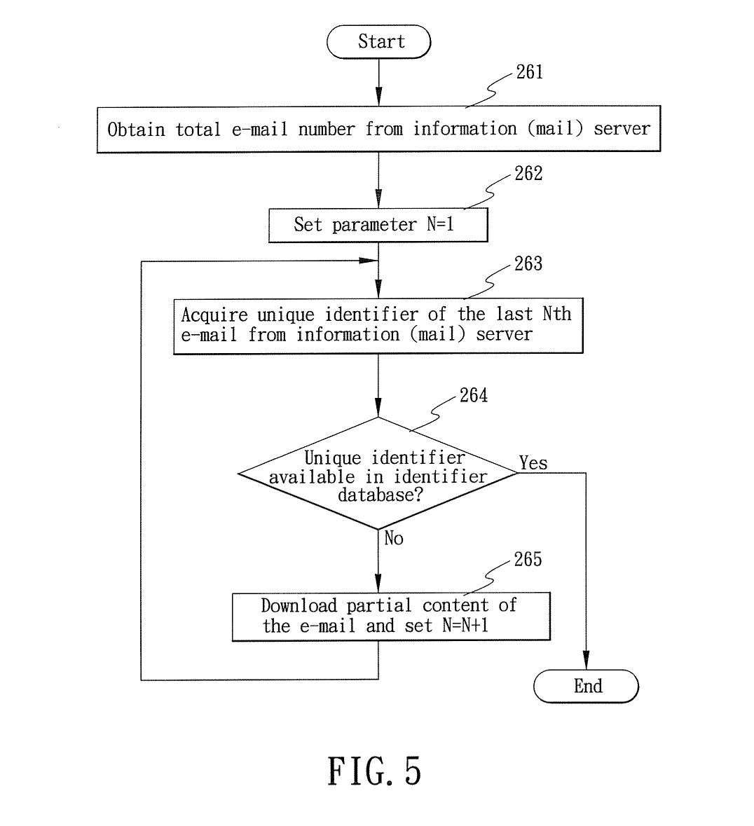

Accordingly, in this embodiment, in order to save network bandwidth and storage space of the memory unit 26, as well as to reduce power consumption of the hand-held mobile communications device 21, when the hand-held mobile communications device 21 is going to acquire e-mail in the information server 31 (e.g., a POP3 mail server), as shown in step 261 in FIG. 5, the processing unit 24 of the hand-held mobile communications device 21 will first request the information server 31 (POP mail server) to report a total number of e-mails (e.g., 1002 e-mails) received thereby. After the processing unit 24 receives the total e-mail number reported by the information server 31 (mail server), in step 262, the processing unit 24 sets a parameter N=1, and proceeds with step 263 to request the information server 31 (mail server) to send the unique identifier (UID) of the last Nth e-mail (i.e., the 1002nd e-mail) thereto. Subsequently, in step 264, the processing unit 24 inspects whether the unique identifier is present in the unique identifier database (which is generally provided in the memory unit 26, not shown) thereof. If the unique identifier is present, this indicates that there is no new e-mail in the information server 31 (mail server), and the e-mail retrieving flow is thus ended. Otherwise, in step 265, the partial content of the e-mail is downloaded, N is set to be equal to N+1 (i.e., corresponding to the 1001st email), and the aforesaid steps 263˜265 are repeated until it is found by inspection that the unique identifier of the last Nth e-mail has been recorded in the unique identifier database (which indicates that the hand-held mobile communications device 21 has received the last Nth e-mail and those before it). Hence, new e-mail in the information server 31 can be easily inspected and downloaded without the need to retrieve the unique identifiers of all the e-mails stored in the information server 31 for comparison one by one, thereby providing preliminary screening of the e-mail. As a result, the bandwidth and time for downloading the unique identifiers can be reduced, and since there is no need to inspect a large number of unique identifiers, power consumption of the hand-held mobile communications device 21 can also be saved.

Certainly, the above method is merely directed to POP3 mail servers or other mail servers providing unique identifiers of e-mail. For more powerful mail servers that can provide search/query functions, e.g., IBM Domino mail server or the like, since the IBM Domino mail server can allow setting of mail accessing time, the hand-held mobile communications device 21 according to this preferred embodiment can send requests to the IBM Domino mail server at predetermined times for transmission of partial content of e-mail received by the IBM Domino mail server within a certain period of time. For instance, the hand-held mobile communications device 21 inquires the IBM Domino mail server at 10:00 a.m. about whether new e-mail was received after 9:30 a.m. If new e-mail is available, partial content of the new e-mail is downloaded. After half an hour, i.e., at 10:30 a.m., the hand-held mobile communications device 21 inquires the IBM Domino mail server again about new e-mail received after 10:00 a.m. If new e-mail is available, partial content thereof is downloaded. The hand-held mobile communications device 21 conducts preliminary e-mail screening by means of such inquiry scheme.

After step 42 is ended, in step 43, according to the filtering rules preset by the user, the processing unit 24 screens the acquired partial content (of the e-mail), e.g., the senders, the subjects, or partial text of the e-mail are screened, to rule out unwanted e-mail, and downloads the e-mail that complies with the preset filtering rules according to the filtering result for temporary storage in the memory unit 26.

Then, step 44 is carried out to determine whether or not to send a notification to alert the user based on a previous setting by the user. For instance, if the setting of the user is to issue a notification before the user decides whether or not to read the mail, step 45 is performed to generate and display a notification on a screen of the hand-held mobile communications device 21 to notify the user of receipt of new e-mail. Then, in step 46, the processing unit 24 waits for the user to issue a read-mail command and, whereupon, carries out step 47 to read the mail from the memory unit 26 and display the mail on the display screen of the hand-held mobile communications device 21. On the contrary, if the user's previous setting in step 44 is to read the mail directly, a notification will not be issued, and the flow skips to step 47 to enable the processing unit 24 to read the mail from the memory unit 26 directly and to display the mail on the screen of the mobile communications device 21.

The above is a brief description of the flow of the application program in this embodiment. The method of use and the operational flow of the hand-held mobile communications device 21 will now be described in detail in the succeeding paragraphs.

Referring to FIG. 2, before the mobile mail function of the hand-held mobile communications device 21 can be used, an initialization procedure with respect to the hand-held mobile communications device 21 has to be conducted through a personal computer 32.

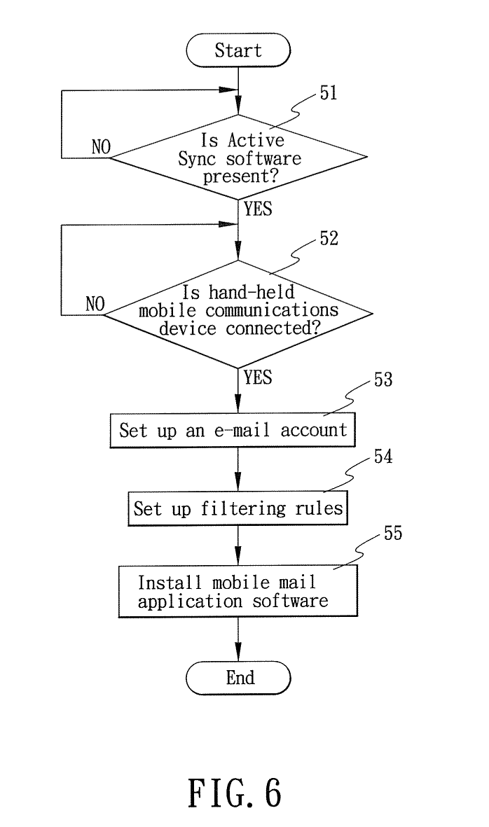

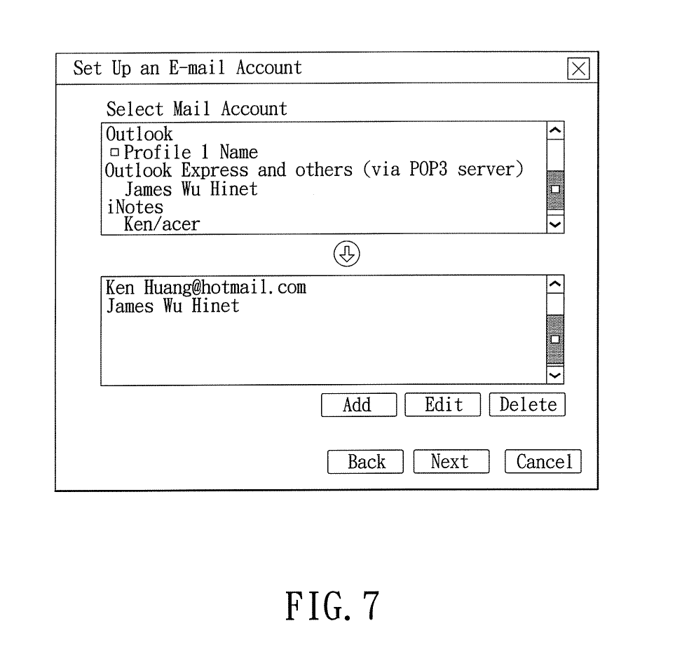

Referring to FIG. 6, in step 51, before commencement of the initialization procedure, the personal computer 32 is enabled to inspect whether the hand-held mobile communications device 21 has installed therein software (e.g., the conventional Active sync software) that allows access to the hand-held mobile communications device 21 by the personal computer 32. After confirming the presence of such software, in step 52, the personal computer 32 inspects whether the hand-held mobile communications device 21 is connected to the personal computer 32. If yes, the flow goes to step 53, in which a “Set Up an E-mail Account” screen as shown in FIG. 7 is displayed on the personal computer 32. In the upper text box of the screen, there is shown mail server account information (Profile 1 Name, Profile 2 Name, James Wu Hinet, . . . etc.) of a mail handler (e.g., Outlook or Outlook Express) in the personal computer 32 available for the user's selection and addition to the lower text box of the screen so as to set the mail server to be searched.

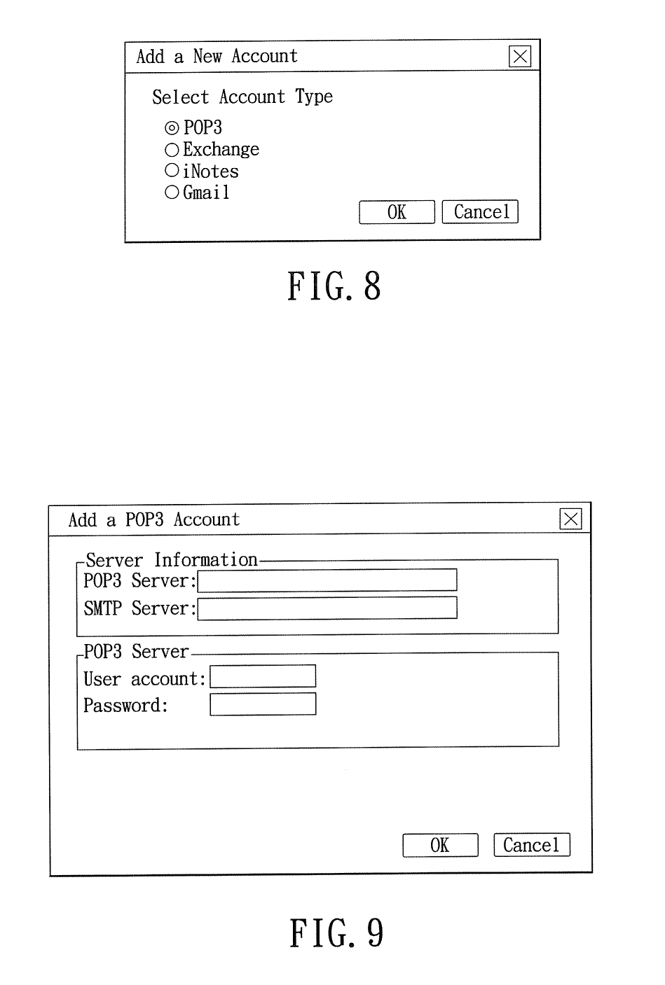

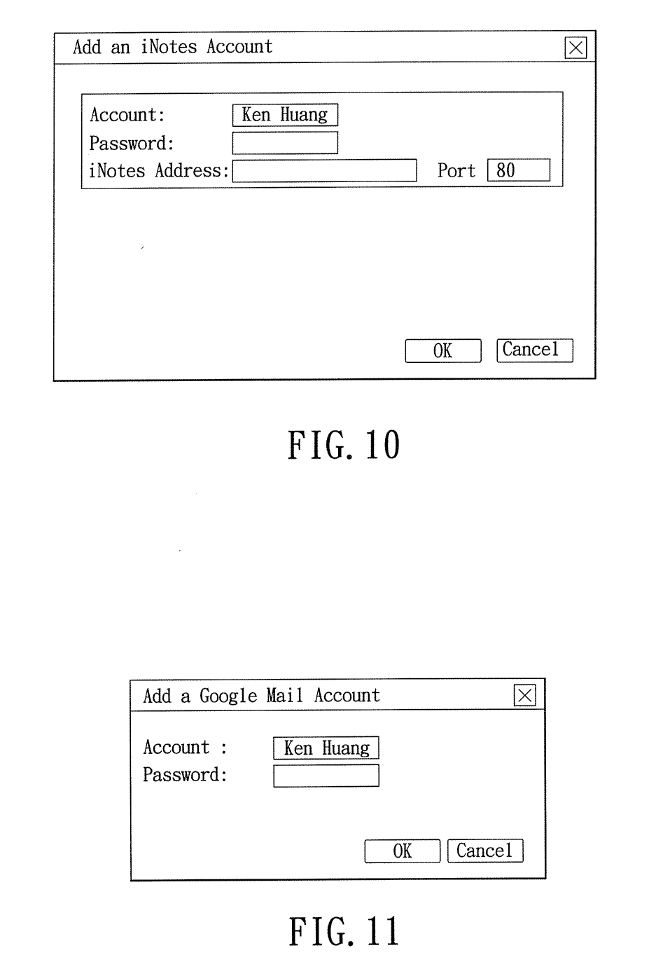

At the same time, command options of “Add,” “Edit,” “Delete,” etc., are displayed at a lower portion of the screen. When the user selects the “Add” command option, a screen entitled “Add a New Account” such as that shown in FIG. 8 will appear, listing a number of mail server accounts, e.g., POP3, Exchange, iNotes, and Gmail, for the user's selection. When the user selects “POP3,” a screen entitled “Add a POP3 Account” as shown in FIG. 9 will appear to allow the user to set relevant information of the mail server (incoming mail server POP3 and outgoing mail server SMTP), such as server address, user account and password. When the user chooses “iNotes” or “Gmail,” on the screen of FIG. 8, an “Add an iNotes Account” screen as shown in FIG. 10, or an “Add a Google Mail Account” screen as shown in FIG. 11, will appear to allow the user to input information such as mail account and password or mail address (for iNotes). After the user has finished inputting such information and has clicked on the “OK” option, the personal computer 32 will inspect the accuracy of the data inputted by the user before proceeding with the search for the newly added mail account. After locating the mail account, the mail account will be added to the lower text box of the screen of FIG. 7. In addition, the user can also choose “Edit” or “Delete” on the screen of FIG. 7 to edit the mail account data or delete the mail account.

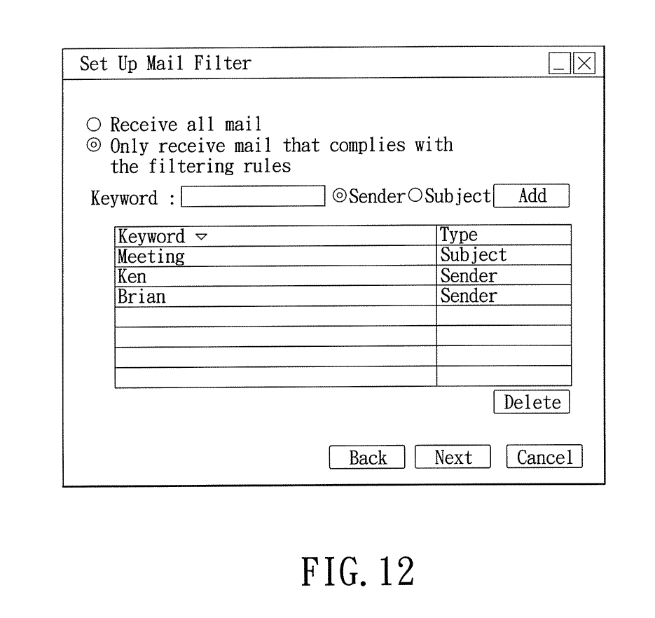

After the user has set the mail account in the “Set Up an E-Mail Account” screen and selected the “Next” command option thereon, in step 54, a screen entitled “Set Up Mail Filter” as shown in FIG. 12 will appear to allow the user to set filtering rules. The user can enter one or more keywords in the “keyword” box on the screen, and choose the “sender” or “subject” option button to relate the entered keyword/keywords to the sender or the subject of an e-mail message. By clicking the “Add” option, the keyword/keywords can be added to the filtering rule box at the lower part of the screen. The setup data will be recorded in the processing unit 24. After the settings are completed, in step 55, the personal computer 32 executes a software install procedure with respect to the hand-held mobile communications device 21 to install another application program for executing a mobile mail service into the hand-held mobile communications device 21. After installation, the hand-held mobile communications device 21 will have a mobile mail function.

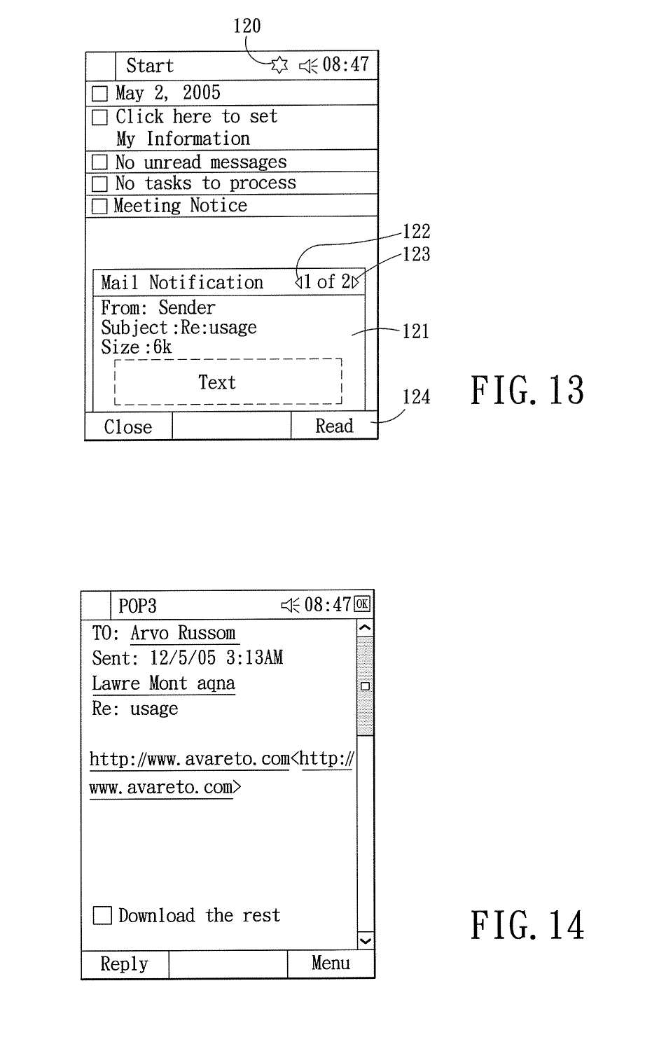

Therefore, referring to FIG. 13, when the processing unit 24 of the hand-held mobile communications device 21 acquires partial content of the mail in the information server 31, filters the partial content according to the filtering rule, and downloads the mail that complies with the filtering result, an incoming notification will be generated to notify the user to check the hand-held mobile communications device 21. The incoming notification may be a ringing tone or vibration. Moreover, a visible incoming notification icon, such as a star-shaped icon 120, will be displayed on a home page screen of the hand-held mobile communications device 21 as shown in FIG. 13. The user can customize or edit the form of the incoming notification as well as edit the icon 120. Therefore, when the user clicks on the star-shaped icon 120, a message window 121 will open at the lower part of the home page screen to display a mail notification message, which includes the sender of the mail, the subject of the mail, and the size of the mail. At the same time, a “Read” option 124 is shown at the bottom of the home page screen to allow the user to read the text of the mail upon clicking the “Read” option 124. Furthermore, when there are several notification messages from the hand-held mobile communications device 21, the number of the notification messages will be shown at the right upper corner of the message window 121, and left and right arrows 122, 123 are provided to allow the user to choose to read the notification messages of interest.

In addition, the message window 121 maybe a customized message window that allows the user to edit settings of the message window.

Furthermore, aside from being configured to send a notification in advance, the processing unit 24 of the hand-held mobile communications device 21 may also be set to automatically display the text (content) of the mail, including the sender, the subject, and the size of the mail, upon obtaining mail that complies with the filtering rules according to the filtering result.

In addition, since the processing unit 24 downloads the text of the mail in whole or in part (depending on the size of the mail) when downloading the mail, in case the mail is not downloaded in its entirety or there is an attachment to the mail, referring to FIG. 14, when the content of the mail is being displayed on the display screen of the hand-held mobile communications device 21, a “Download the Rest” option will appear at the bottom of the screen to allow the user to choose to download the rest of the content of the mail.

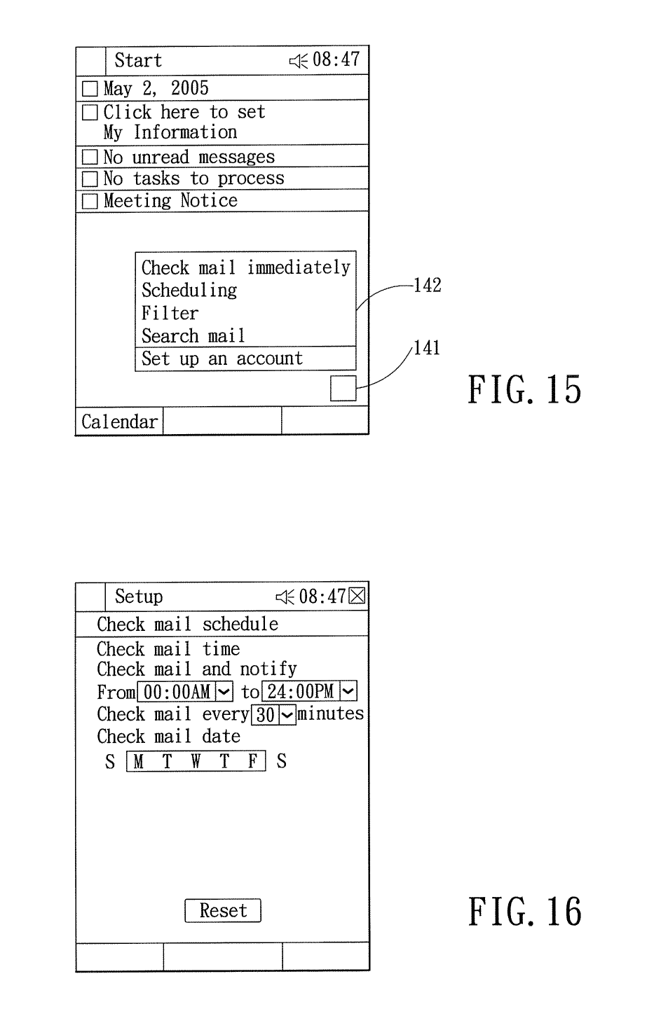

Referring to FIG. 15, a virtual button 141 is further provided at a lower right corner of the home page screen of the hand-held mobile communications device 21. Upon clicking the virtual button 141, a menu 142 displaying several choices including “Check Mail Immediately,” “Scheduling,” “Filter,” “Search Mail,” and “Set Up Account” is shown. When the user clicks “Check Mail Immediately,” the processing unit 24 will be activated to search the information server 31 for any new mail so as to acquire partial content of the new mail for filtering and so as to download the mail that complies with the filtering rule according to the filtering result, and to display the search results, as shown in FIG. 13. When the “Scheduling” option is clicked, the display screen of the hand-held mobile communications device 21 will display a “Set Up” page, as shown in FIG. 16, and the user can set the mail checking time of the processing unit 24 on the “Set Up” page to enable the application program to activate the processing unit 24 to search for mail data in the information server 31 at preset times according to the time setting.

Furthermore, to ensure the accuracy of the date and time for the processing unit 24 to perform data searches, the hand-held mobile communications device 21 can also be automatically connected to a clock server on the Internet at predetermined times so as to permit automatic calibration of the time of the real time clock 25.

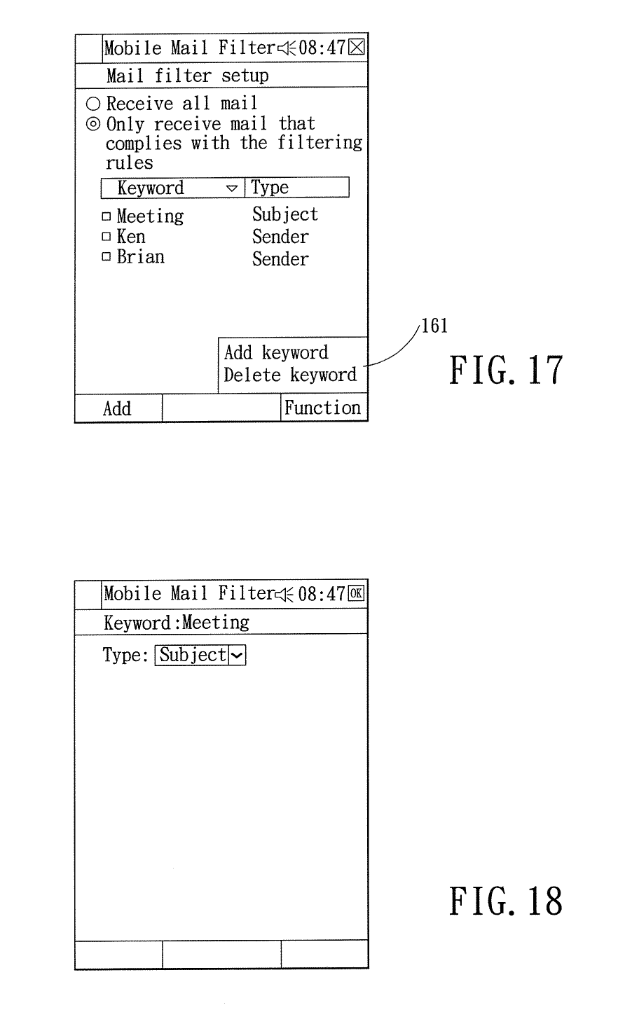

When the user chooses the “Filter” option of the menu 142 in the screen of FIG. 15, a screen entitled “Mobile Mail Filter” as shown in FIG. 17 will appear, showing the original filtering rule settings, with a menu 161 containing options of “Add Keywords” and “Delete Keywords” to allow the user to choose to add or delete a keyword to be searched, as shown in FIG. 18.

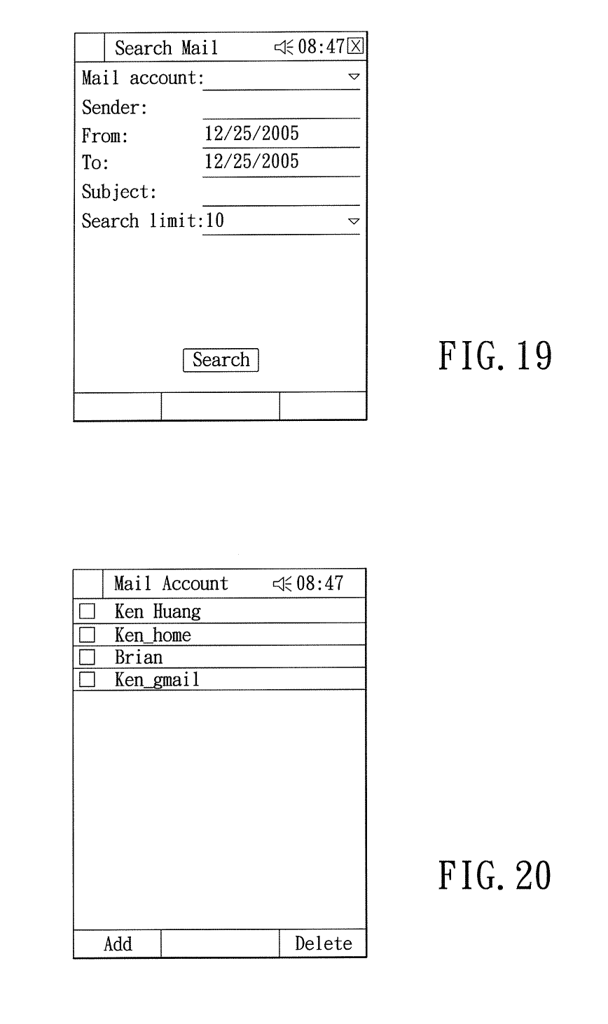

When the user chooses the “Search Mail” option of the menu 142 in the screen of FIG. 15, a “Search Mail” screen as shown in FIG. 19 will pop up to allow the user to enter search parameters, e.g., mail account, sender, time period, subject, etc. The processing unit 24 of the hand-held mobile communications device 21 will immediately access the information server 31 to search for e-mail based on the search parameters, and display the search results, as shown in FIG. 13.

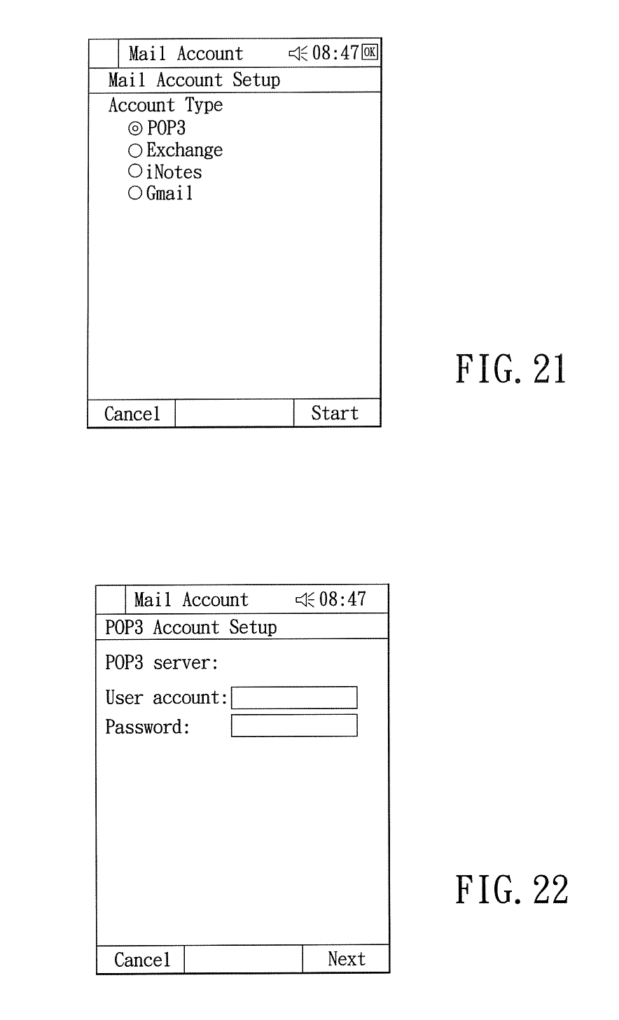

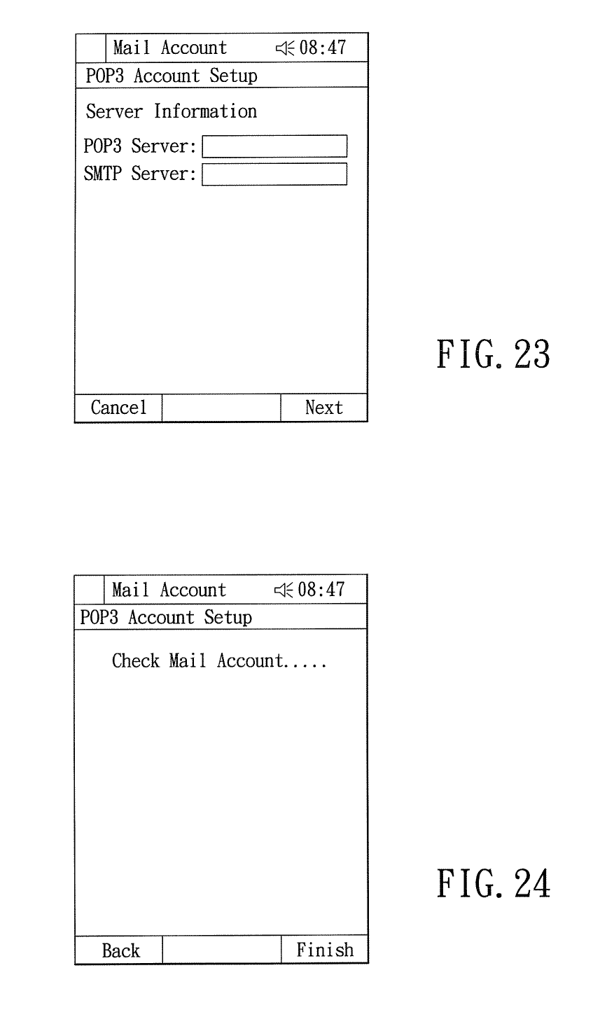

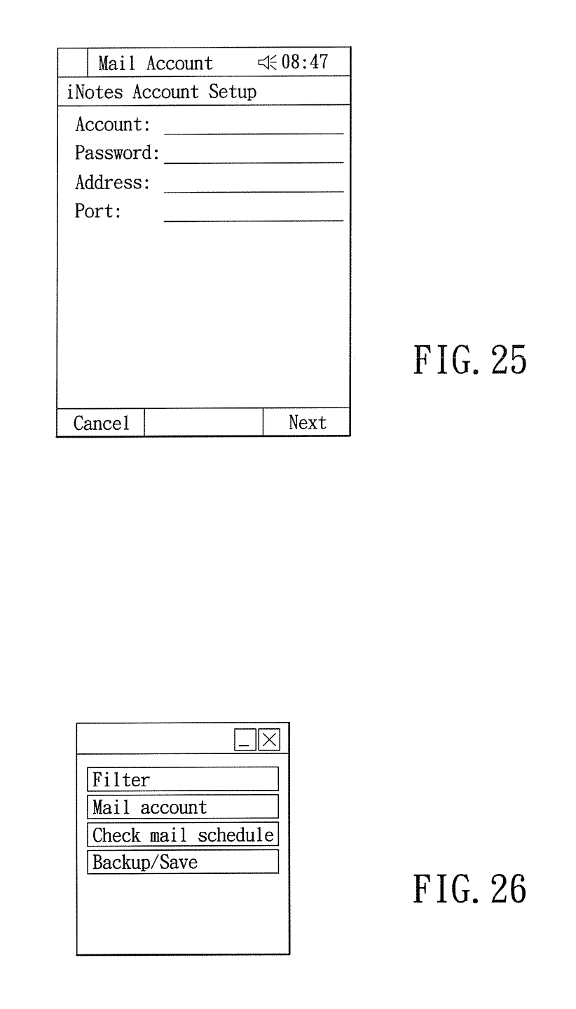

When the “Set up an account” option of the menu 142 in the screen of FIG. 15 is chosen, a screen entitled “Mail Account” as shown in FIG. 20 will appear, showing the currently set mail accounts. At the same time, “Add” and “Delete” options are provided at the bottom of the screen to allow the user to choose to add or delete a mail account. When the user chooses the “Add” option, a screen entitled “Mail Account Settings” as shown in FIG. 21 will appear to allow the user to select the type of account, e.g., POP3, Exchange, iNotes, or Gmail. If the type of account selected by the user is POP3 or Gmail, windows such as those respectively shown in FIGS. 22 and 23 will appear in sequence to allow the user to set relevant information, e.g., to enter the user account number, password, server address, etc. Then, a screen as shown in FIG. 24 will appear to confirm the data inputted by the user so as to add a new account. On the other hand, if the type of account selected by the user is Exchange or iNotes, a window as shown in FIG. 25 will appear to allow the user to enter relevant information, and a checking procedure as illustrated in FIG. 24 is performed to add a new mail account.

After the hand-held mobile communications device 21 has undergone the initialization procedure on first use, if the user wants to change the settings of the hand-held mobile communications device 21 through the personal computer 32, the hand-held mobile communications device 21 is connected to the personal computer 32, and the personal computer 32 will display a menu (see FIG. 26) including the options “Filter,” “Mail Account,” “Check Mail Schedule,” and “Backup/Save” for the user to choose. The process for setting the “Filter,” the “Mail Account,” and the “CheckMail Schedule” is the same as that described heretofore (see FIGS. 17-18, FIGS. 20-25, and FIG. 16), and will not be discussed further herein.

The “Backup/Save” option allows the user to store the setup data in the personal computer 32, or, in case of damage to the original setup data in the hand-held mobile communications device 21, to use the backup copy of the setup data stored in the personal computer 32 to replace the damaged setup data in the hand-held mobile communications device 21.

In addition, the hand-held mobile communications device 21 of this embodiment not only can screen e-mail, it can also screen web page information provided by the information server 31. The information server 31 referred to in this case is a web server which can supply articles published in different blogs, or news information provided by different websites (e.g., Yahoo news).

In the same manner as that described hereinabove, the processing unit 24 of the hand-held mobile communications device 21 can go to the information server 31 at predetermined times to acquire partial web page content of web page information. That is, the hand-held mobile communications device 21 can send requests to the information server 31 at predetermined times for transmission of partial content of web page information received thereby within a certain period of time. For instance, the hand-held mobile communications device 21 inquires the information server 31 at 2:00 p.m. about whether new web page information was received after 1:30 p.m. In the affirmative, partial content of web page information received between 1:30 p.m. and 2:00 p.m. is downloaded. After half an hour, i.e., at 2:30 p.m., the hand-held mobile communications device 21 further inquires the information server 31 about receipt of new web page information after 2:00 p.m. In the affirmative, the partial content of the web page information received between 2:00 p.m. and 2:30 p.m. is downloaded. Subsequently, in a manner similar to that described above, the hand-held mobile communications device 21 filters the downloaded partial content of the web page information according to the filtering rule (keywords relating to web page source, subject, text, etc.) set in the filter of the processing unit 24 so as to download the web page information complying with the filtering rule (i.e., of interest to the user) according to the filtering result, and issues notifications to alert the user to read the filtered web page information or directly displays the web page information of interest to the user for the user to browse the information provided on the web page through a hyperlink.

In this embodiment, by making a preliminary screening setting in the information server through the hand-held mobile communications device 21 to eliminate old information in the information server and to acquire new information, and by setting a filtering rule in the hand-held mobile communications device 21 so that the hand-held mobile communications device 21 can first acquire partial content of the new information, filter the partial content according to the filtering rule set by the user and download the full information that complies with the filtering rule in the information server according to the filtering result, and then issue a notification to alert the user to read the filtered information, the user will not receive unwanted information through the hand-held mobile communications device 21, and, as acquisition of the information does not need to go through a third party, no additional telecommunications service fees are required. Besides, the integrity and confidentiality of the information can be ensured. Thus, the intended effect and object of this invention can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for acquiring information adapted to be implemented in a hand-held mobile communications device so as to access information in a remote information server through the Internet, said method comprising:
(A) acquiring partial content of information from the information server at predetermined times;
(B) filtering the acquired partial content according to a filtering rule; and
(C) according to the filtering result, downloading information that complies with the filtering rule, and according to a user setting, displaying one of the information that complies with the filtering rule and a notification message relating to the information that complies with the filtering rule.

2. The method of claim 1, wherein the information server is a mail server, the information is electronic mail stored temporarily in the mail server, and the partial content is one of sender, subject, and partial text of the electronic mail.

3. The method of claim 2, wherein the filtering rule defines search and filtering parameters of at least one keyword in the partial content of the electronic mail.

4. The method of claim 1, wherein the hand-held mobile communications device is provided with an identifier database for recording unique identifiers of electronic mail, and step (A) includes:
(A0) requesting the mail server to report a total electronic mail number;
(A1) setting a parameter N=1;
(A2) enabling the mail server to send a unique identifier of a last Nth electronic mail;
(A3) inspecting whether the unique identifier of the last Nth electronic mail is stored in the identifier database, downloading partial content of the last Nth electronic mail if the unique identifier thereof is not present, and setting N=N+1; and
(A4) repeating steps (A2) and (A3) until presence of the unique identifier in the identifier database is inspected.

5. The method of claim 2, wherein step (A) includes requesting the mail server to transmit at predetermined times the total electronic mail number received within a predetermined period of time counting back from the time the request was received.

6. The method of claim 1, wherein the information server is a web server, the information is web page information stored temporarily in the web server, and the partial content is partial web page content stored temporarily in the web server, the partial web page content being filtered according to the filtering rule in step (B).

7. The method of claim 6, wherein the partial web page content includes one of a source, an author, a subject, and text of the web page, and the filtering rule in step (B) defines search parameters of at least one keyword in the partial web page content.

8. The method of claim 7, wherein, in step (A), the web server is requested to transmit at predetermined times the partial web page content of web pages received within a predetermined period counting back from the time a request was received.

9. The method of claim 1, wherein, in step (C), when the notification message is displayed according to the user setting, and the notification message is accompanied by an incoming notification to alert the user to check the notification message.

10. The method of claim 9, wherein the incoming notification is in the form of one of a ringing tone, vibrations, and a visible signal, and the form of the incoming notification is a customized form set by the user.

11. A hand-held mobile communications device adapted to access information in a remote information server through the Internet, said hand-held mobile communications device comprising:
a communications unit for communicating with the information server; and
a processing unit for acquiring partial content of information from the information server at predetermined times through said communications unit, for filtering the acquired partial content according to a filtering rule, for downloading information that complies with the filtering rule according to the filtering result, and for selectively displaying one of the information that complies with the filtering rule and a notification message relating to the information that complies with the filtering rule according to a user setting.

12. The hand-held mobile communications device of claim 11, wherein said communications unit supports at least one wireless communications protocol selected from the group comprising GPRS, WCDMA, CDMA2000 and WI-FI.

13. The hand-held mobile communications device of claim 12, wherein said processing unit is loaded with an operating system capable of accessing the information in the information server through said communications unit.

14. The hand-held mobile communications device of claim 11, further comprising a memory unit for storing temporarily the partial content acquired by said processing unit and the information that complies with the filtering rule.

15. The hand-held mobile communications device of claim 14, wherein the information server is a mail server, the information is electronic mail stored temporarily in the mail server, the partial content is one of sender, subject, and partial text of the electronic mail, and the memory unit is provided with an identifier database for recording unique identifiers of electronic mail, said processing unit executing the following steps when acquiring the partial content of the electronic mail from the mail server:
(A0) requesting the mail server to report a total electronic mail number;
(A1) setting a parameter N=1;
(A2) enabling the mail server to send a unique identifier of a last Nth electronic mail;
(A3) inspecting whether the unique identifier of the last Nth electronic mail is stored in the identifier database, downloading partial content of the last Nth electronic mail if the unique identifier thereof is not present, and setting N=N+1; and
(A4) repeating steps (A2) and (A3) until presence of the unique identifier in the identifier database is inspected.

16. The hand-held mobile communications device of claim 11, wherein the information server is a mail server, the information is electronic mail stored temporarily in the mail server, the partial content is one of sender, subject, and partial text of the electronic mail, and said processing unit requests the mail server to transmit at predetermined times the total electronic mail number received within a predetermined period of time counting back from the time the request was received.

17. The hand-held mobile communications device of claim 11, wherein the information server is a web server, the information is web page information stored temporarily in the web server, the partial content is partial web page content stored temporarily in the web server, and said processing unit requests the web server to transmit at predetermined times the partial web page content of web pages received within a predetermined period counting back from the time a request was received.

18. The hand-held mobile communications device of claim 11, further comprising a real time clock to allow for setting of times for said processing unit to search the information in the information server such that said processing unit can be activated at the predetermined times to search the information in the information server.

19. The hand-held mobile communications device of claim 18, further comprising means for calibrating automatically the time of said real time clock through the Internet so as to ensure accuracy of the times for said processing unit to search the information in the information server.

20. The hand-held mobile communications device of claim 11, further comprising a display screen, said processing unit displaying one of the information complying with the filtering rule and the notification message relating to the information complying with the filtering rule on said display screen according to the user setting.

21. The hand-held mobile communications device of claim 20, wherein said processing unit generates an incoming notification concurrently with the displaying of the notification message on said display screen so as to alert the user to check the notification message.

22. The hand-held mobile communications device of claim 21, wherein the notification message is displayed on a home page screen of said display screen in the form of a message window, the message window displaying source, subject and size of the information complying with the filtering rule, the home page screen further providing a “Read” option to allow the user to choose to display contents of the information related to the notification message.

23. The hand-held mobile communications device of claim 11, wherein said processing unit shows the source, subject and size of the information concurrent with display of the information complying with the filtering rule according to the user setting.
